(19) United States
(12) Patent Application Publication
(10) Pub. No.: US 2025/0205720 A1
(43) Pub. Date: Jun. 26, 2025

(54) CANISTER WITH A PUMP FOR DISPERSING LIQUIDS AND METHOD OF USING THE SAME

(71) Applicant: Native Pet, Inc, St. Louis, MO (US)

(72) Inventors: Patrick Barron, St. Louis, MO (US); Daniel Schaefer, St. Louis, MO (US)

(21) Appl. No.: 18/983,728

(22) Filed: Dec. 17, 2024

Related U.S. Application Data
(60) Provisional application No. 63/613,895, filed on Dec. 22, 2023.

(51) Int. Cl. B05B 11/00; B05B 11/10

(52) U.S. Cl. CPC B05B 11/0008; B05B 11/1001

(57) ABSTRACT

Provided herein are systems and methods for a Cannister with a pump for dispersing liquids.

### CROSS-REFERENCE TO RELATED APPLICATIONS

The present application claims priority to U.S. provisional application Ser. No. 63/613,895, filed Dec. 22, 2023, herein incorporated by reference in its entirety.

### BACKGROUND

The invention generally relates to a pump for dispersing liquids.

The disadvantages of common packaging components use plastic bottles and pumps. In contrast, tin bases are also used as premium olive oil packaging and do not include pumps, especially in the beauty/food industries. The present invention attempts to solve these problems as well as others.

### SUMMARY OF THE INVENTION

Provided herein are systems and methods for a Cannister with a pump for dispersing liquids.

The methods, systems, and apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

Accordingly, it is an object of the invention not to encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. § 112, first paragraph) or the EPO (Article 83 of the EPC), such that Applicants reserve the right and hereby disclose a disclaimer of any previously described product, process of making the product, or method of using the product. It may be advantageous in the practice of the invention to be in compliance with Art. 53 (c) EPC and Rule 28 (b) and (c) EPC. All rights to explicitly disclaim any embodiments that are the subject of any granted patent(s) of applicant in the lineage of this application or in any other lineage or in any prior filed application of any third party is explicitly reserved. Nothing herein is to be construed as a promise.

### BRIEF DESCRIPTION OF THE DRAWINGS

In the accompanying figures, like elements are identified by like reference numerals among the several preferred embodiments of the present invention.

FIG. 1A is a top perspective view of the cannister for dispersing liquids, according to one embodiment.

FIG. 1B is a top view of the cannister for dispersing liquids, according to one embodiment.

FIG. 1C is a side view of the cannister for dispersing liquids, according to one embodiment.

FIG. 2 is a cross-sectional side view of the pump, according to one embodiment.

FIG. 3A is a top perspective view of the plug, according to one embodiment.

FIG. 3B is a bottom perspective view of the plug, according to one embodiment.

FIG. 3C is a cross-sectional side view of the plug, according to one embodiment.

### DETAILED DESCRIPTION OF THE INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

Embodiments of the invention will now be described with reference to the Figures, wherein like numerals reflect like elements throughout. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

The words proximal and distal are applied herein to denote specific ends of components of the instrument described herein. A proximal end refers to the end of an instrument nearer to an operator of the instrument when the instrument is being used. A distal end refers to the end of a component further from the operator and extending towards the surgical area of a patient and/or the implant.

The use of the terms “a” and “an” and “the” and similar referents in the context of describing the invention are to be construed to cover both the singular and the plural, unless otherwise indicated herein or clearly contradicted by context. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any nonclaimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As used herein the term “method” refers to manners, means, techniques and procedures for accomplishing a given task including, but not limited to, those manners, means, techniques and procedures either known to, or readily developed from known manners, means, techniques and procedures by practitioners of the mechanical and chemical arts. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### DESCRIPTION OF EMBODIMENTS

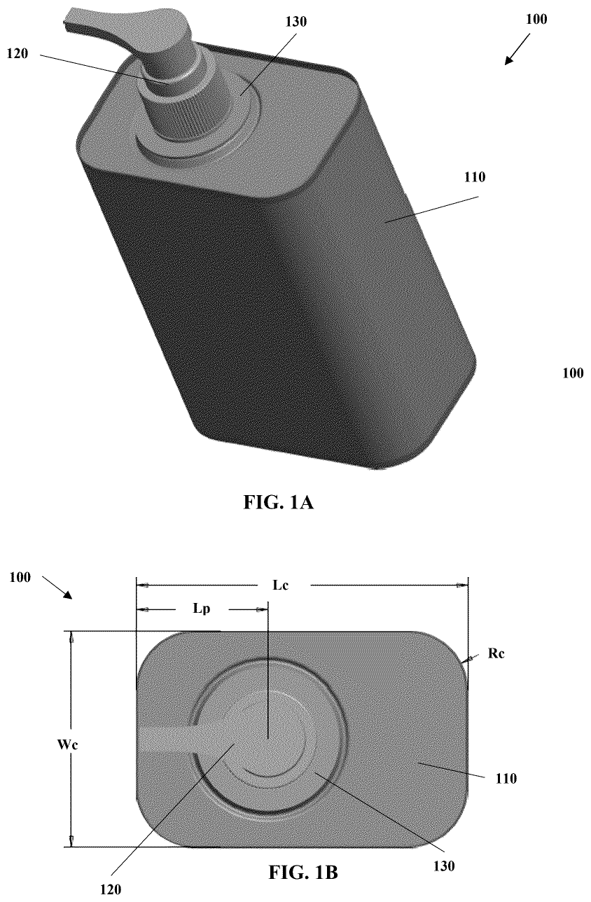

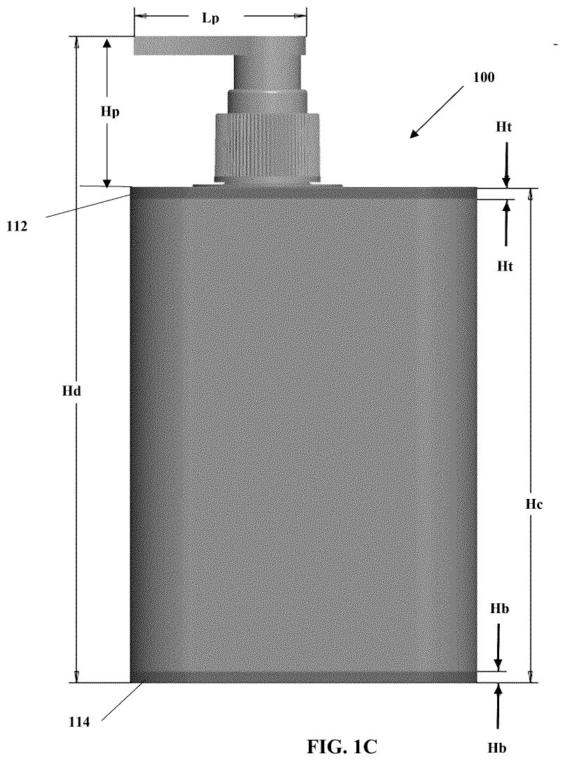

Generally speaking, the cannister for dispersing liquids 100 comprises a canister 110 to contain liquid material and affixing a plastic pump 120 onto the metal canister so its contents can be dispersed via pumping, as shown in FIG. 1A-1C.

The cannister 110 comprises a base 114 with seamed bottom ends and a top portion 112 with seamed top ends, as shown in FIG. 1C. As shown in FIGS. 1A-1B, a plastic plug 130 is operable as an interface medium, and the plastic pump 120 screws onto the plastic plug 130 to create a seal between the plug 130 and the pump 120. The custom plug 130 creates a seal for liquid contents and acts as an interface between the canister 110 and plastic pump 120.

As shown in FIG. 1B, the pump 120 includes a length Lp from the center of the pump to the end of the cannister 110. The cannister 110 includes a width Wc and a length Lc. The interface between the width Wc and length Lc includes a radius of curvature Rc. In one embodiment, the width Wc is between about 50 mm and about 60 mm, alternatively, between about 52 mm and about 58 mm, alternatively, between about 54 mm and about 56 mm. In one embodiment, the length Lc is between about 72 mm and about 94 mm, alternatively, between about 74 mm and about 92 mm, alternatively, between about 76 mm and about 90 mm. In one embodiment, the radius of curvature Rc is between about 12 degrees and about 18 degrees, alternatively, between about 14 degrees and about 16 degrees, alternatively, about 15.8 degrees.

As shown in FIG. 1C, cannister for dispersing fluids 100 includes a height Hd including the pump height and the cannister height. The cannister 110 includes a cannister height Hc. And the pump 120 includes a pump height Hp. The top portion 112 includes a height Ht and the bottom portion 114 includes a height Hb. In one embodiment, the height Hd is between about 140 mm and about 170 mm, alternatively, between about 142 mm and about 168 mm, alternatively, between about 146 mm and about 166 mm. In one embodiment, the pump height Hp is between about 34 mm and 40 mm, alternatively, between about 36 mm and about 39 mm, alternatively, between about 37 mm and about 38 mm. In one embodiment, the cannister height Hc is between about 104 mm and about 132 mm, alternatively, between about 106 mm and about 130 mm, alternatively, between about 106 mm and about 128 mm.

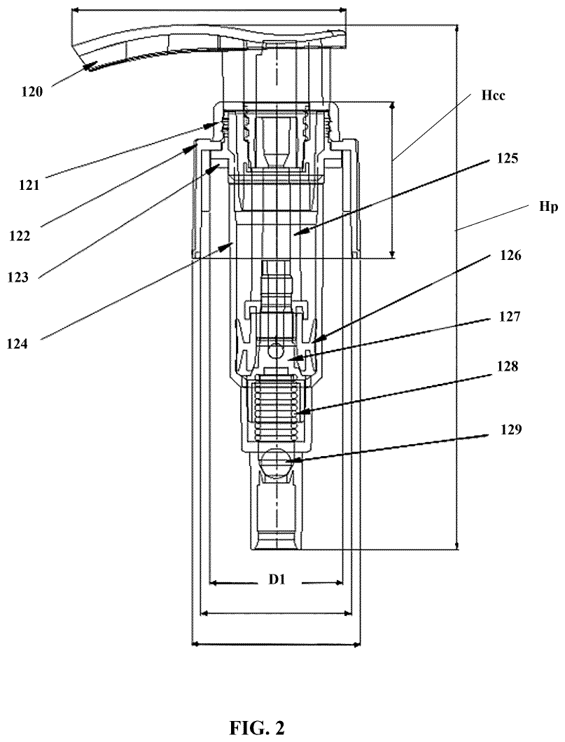

As shown in FIG. 2, the pump 120 comprises a connecting cap 121, a closure 122, a gasket 123, a housing 124, a piston rod 125, a piston 126, a piston seat 127, a spring 128, and a ball 120. The closure 122 includes a diameter Dc, the gasket 123 includes a diameter Dg, the pump 120 includes a diameter Dp, and the connecting cap includes a height Hcc and the pump 120 includes the pump height Hp. The closure 122 includes an inner threaded portion that engages with the plug 130 to tighten thereupon. The closure 121 includes a diameter D1 to concentrically engage with the plug 130, as described below.

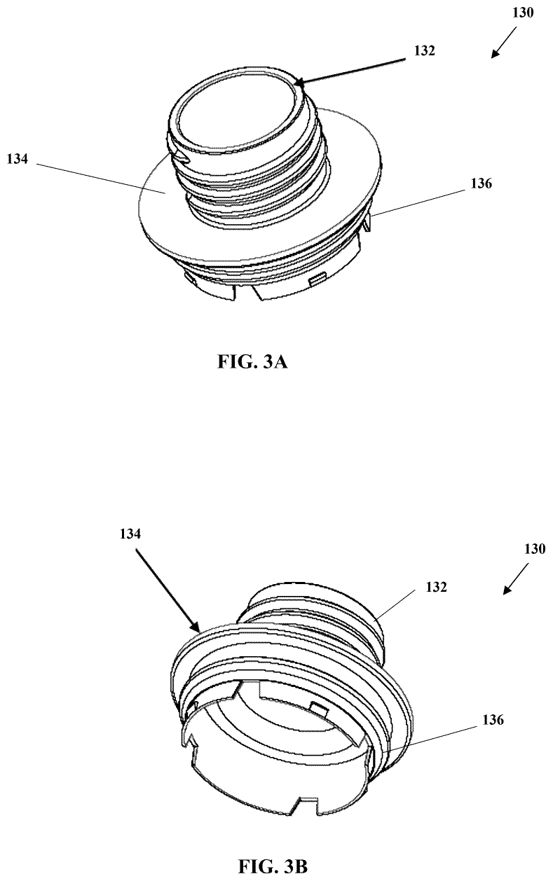

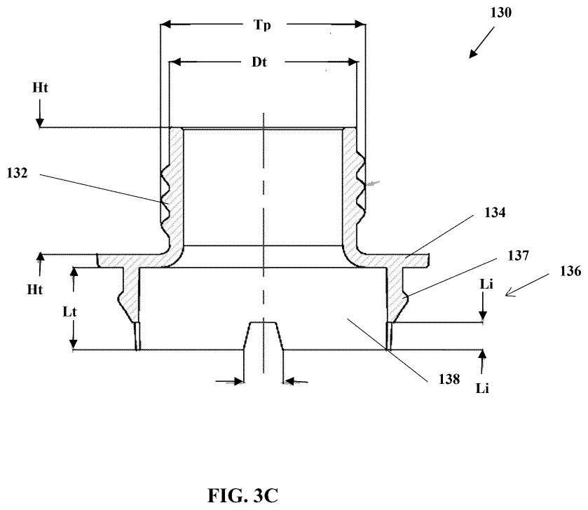

As shown in FIGS. 3A-3B, the plug 130 includes a cylindrical top portion 132, a middle sealing portion 134, and a bottom engagement portion 136. The cylindrical top portion 132 engages with the pump 120 while the sealing portion 134 creates a fluid tight seal against the top of the cannister, and the bottom engagement portion 136 locks the plug 130 into the fluid tight seal against the top of the cannister 110. As shown in FIG. 3C, the bottom engagement portion 136 includes a circular tab 137 that lock against the top portion of the cannister opening and a plurality of insert tabs 138 to further prevent movement of the plug 130 once engaged with the cannister 110. The cylindrical top portion 132 includes a diameter Dt that concentrically engages with the pump 120. The cylindrical top portion 132 includes a threaded portion Tp to concentrically lock and seal the pump 120 on the top portion of the plug 130. The cylindrical top portion 132 includes a height Ht. The circular tab 137 includes a length Lt that is sufficient to engage and lock against the top opening of the cannister. The insert tabs 138 include a locking tab Li that extends outward from the insert tab 138, that further prevents movement of the plug 130 and creates a fluid tight seal with the cannister opening.

In operation, the cannister for dispersing fluids includes a unique plug design (i.e., interface) which acts a seal between pump and liquid contents within the cannister, as well as a way to screw on the pump. In one embodiment, the pump is affixed to a metal cannister. In one embodiment, the opacity of the cannister is fully opaque to prevent light penetration through cannister, which will degrade contents especially oils. In one embodiment, the cannister includes a tin packaging.

All publications and patent applications mentioned in this specification are herein incorporated by reference to the same extent as if each individual publication or patent application was specifically and individually indicated to be incorporated by reference.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A cannister for dispersing fluids, comprising: a canister to contain liquid material and affixing a pump onto the metal canister so the liquid material are be dispersed through a pumping action;
a. the cannister comprises a base with seamed bottom ends and a top portion with seamed top ends, the cannister comprises a plug operable as an interface medium, and the plastic pump screws onto the plug to create a seal between the plug and the pump.

2. The cannister of claim 1, wherein the pump includes a length Lp from the center of the pump to the end of the cannister; the cannister includes a width Wc and a length Lc; the interface between the width Wc and length Lc includes a radius of curvature Rc; wherein the width Wc is between about 50 mm and about 60 mm, alternatively, between about 52 mm and about 58 mm, alternatively, between about 54 mm and about 56 mm; the length Lc is between about 72 mm and about 94 mm; the radius of curvature Rc is between about 12 degrees and about 18 degrees.

3. The cannister of claim 2, wherein the cannister includes a height Hd including the pump height and the cannister height; The cannister includes a cannister height Hc; the pump includes a pump height; the top portion includes a height Ht and the bottom portion includes a height Hb; the height Hd is between about 140 mm and about 170 mm; the pump height Hp is between about 34 mm and 40 mm; the cannister height Hc is between about 104 mm and about 132 mm.

4. The cannister of claim 3, wherein the pump comprises a connecting cap, a closure, a gasket, a housing, a piston rod, a piston, a piston seat, a spring, and a ball; the closure includes a diameter Dc, the gasket includes a diameter Dg, the pump includes a diameter Dp, and the connecting cap includes a height Hcc and the pump includes the pump height Hp; the closure includes an inner threaded portion that engages with the plug to tighten thereupon; the closure includes a diameter D1 to concentrically engage with the plug.

5. The canister of claim 4, wherein the plug includes a cylindrical top portion, a middle sealing portion, and a bottom engagement portion; the cylindrical top portion engages with the pump while the sealing portion creates a fluid tight seal against the top of the cannister, and the bottom engagement portion locks the plug into the fluid tight seal against the top of the cannister; the bottom engagement portion includes a circular tab that lock against the top portion of the cannister opening and a plurality of insert tabs to further prevent movement of the plug once engaged with the cannister.

6. The cannister of claim 5, wherein the cylindrical top portion includes a diameter Dt that concentrically engages with the pump; the cylindrical top portion includes a threaded portion Tp to concentrically lock and seal the pump on the top portion of the plug; the cylindrical top portion includes a height Ht; the circular tab includes a length Lt that is sufficient to engage and lock against the top opening of the cannister; the insert tabs include a locking tab Li that extends outward from the insert tab, that further prevents movement of the plug and creates a fluid tight seal with the cannister opening.
